(19) United States
(12) Patent Application Publication
(10) Pub. No.: US 2026/0126298 A1
(43) Pub. Date: May 7, 2026

(54) ROUTE GUIDANCE APPARATUS, ROUTE GUIDANCE METHOD, AND PROGRAM

(71) Applicant: Nippon Telegraph and Telephone Corporation, Tokyo (JP)

(72) Inventors: Tsuneko Kura, Musashino-shi, Tokyo (JP); Hiroshi MATSUBARA, Musashino-shi, Tokyo (JP); Akira KOYAMA, Musashino-shi, Tokyo (JP); Naoko KOSAKA, Musashino-shi, Tokyo (JP); Jun KATO, Musashino-shi, Tokyo (JP)

(21) Appl. No.: 18/703,777

(22) PCT Filed: Nov. 2, 2021
(86) PCT No.: PCT/JP2021/040404

§ 371 Date: Apr. 23, 2024

(51) Int. Cl. G01C 21/34; G01C 21/36; G08B 7/06

(52) U.S. Cl. CPC G01C 21/3461; G01C 21/3617; G01C 21/3694; G08B 7/066

(57) ABSTRACT

A route presentation apparatus 1 includes a user state accumulation unit 12 that stores information indicating a state of a user, a route search unit 25 that searches for at least one route to a destination, a required time calculation unit 26 that calculates a required time in response to the state of the user for each of the route, and a search result display unit 27 that displays the route and the required time for the route on a map.

### TECHNICAL FIELD

The present invention relates to a route presentation apparatus, a route presentation method, and a program.

### BACKGROUND ART

In Japan, damage due to heavy rain, typhoons, and the like occurs every year. “Guidelines for Evacuation Information” (Non Patent Literature 1) set by the cabinet office stipulates that disaster prevention information such as information on evacuation and disaster prevention weather information is provided using a five-level “warning level” in order to make people understand various types of information transmitted by the Meteorological Agency and each local government.

By installing an application related to disaster prevention in a smartphone, it is possible to receive various types of disaster prevention information when a disaster occurs. For example, an application related to disaster prevention has a function of searching for a place such as an evacuation place or a public facility included in a disaster prevention map in advance and displaying an elevation from a current position in a graph, or a function of sharing information between users, and provides information for enabling the users to safely evacuate such as an evacuation route.

As an existing technology related to route information, there is known a technology for enabling highly accurate action route estimation by estimating a place and a route where a user will stay in the future using GPS data and expressing a position through which the user passes by a probability distribution for each small area (Patent Literature 1). In addition, there is also known a technology capable of performing appropriate route search according to a moving means even if traveling conditions (accessibility information) assigned to links on a geographical network include unsearched links (Patent Literature 2).

### CITATION LIST

### Patent Literature

Patent Literature 1: JP 2012-042287 A
Patent Literature 2: JP 2020-079734 A

### Non Patent Literature

Non Patent Literature 1: “Guidelines for Evacuation Information”, cabinet office, May 2021 pp. 23-48

### SUMMARY OF INVENTION

### Technical Problem

In a conventional application related to disaster prevention, a user selects an evacuation spot, and a result of searching for a route from a current location to the evacuation spot is indicated on a map. In addition, in general, in a case where a required time to a destination is displayed on the map, the time is calculated in accordance with a walking speed of a healthy person, and is not in accordance with the state of the user (age, health state, or the like). Therefore, in the case of evacuating from the tsunami, for example, the user cannot be aware of the height of the tsunami to reach, and thus cannot ascertain whether or not the selected evacuation spot is in a safe place. Furthermore, since the user does not know the accurate required time until the user arrives at the evacuation spot, the user cannot determine whether or not the user will arrive at the evacuation spot by the tsunami arrival time.

Regarding route information, Patent Literature 1 does not have a function of displaying a route from the current location to a destination in accordance with physical characteristics of a user. In Patent Literature 2, if there is accessibility information, it is possible to select a route in accordance with the physical condition of a user, but time is not taken in to account. Therefore, there is a possibility that evacuation will not be in time in a case where evacuation is performed according to presented information. For example, in a case where a user is walking in the corresponding place within a tsunami arrival time, evacuation cannot be made in time.

The present invention has been made in view of the above, and an object thereof is to present a route suitable for a user.

### Solution to Problem

A route presentation apparatus according to one aspect of the present invention includes: a user state accumulation unit that stores information indicating a state of a user; a route search unit that searches for at least one route to a destination; a required time calculation unit that calculates a required time in response to the state of the user for each of the route; and a search result display unit that displays the route and required time for the route on a map.

In a route presentation method according to one aspect of the present invention, a computer searches for at least one route to a destination, calculates a required time in response to a state of a user for each of the route, and displays the route and the required time for the route on a map.

### Advantageous Effects of Invention

According to the present invention, a route suitable for a user can be presented.

### BRIEF DESCRIPTION OF DRAWINGS

FIG. 1 is a functional block diagram illustrating an example of a configuration of a route presentation apparatus of the present embodiment.

FIG. 2 is a flowchart illustrating an example of a flow of processing of the route presentation apparatus.

FIG. 3 is a diagram illustrating an example of a display screen presenting a route for people with weak legs and hips.

FIG. 4 illustrates an example of a display screen presenting a route for active people.

FIG. 5 is a diagram illustrating an example of a hardware configuration of the route presentation apparatus.

### DESCRIPTION OF EMBODIMENTS

An embodiment of the present invention will be described below using the drawings.

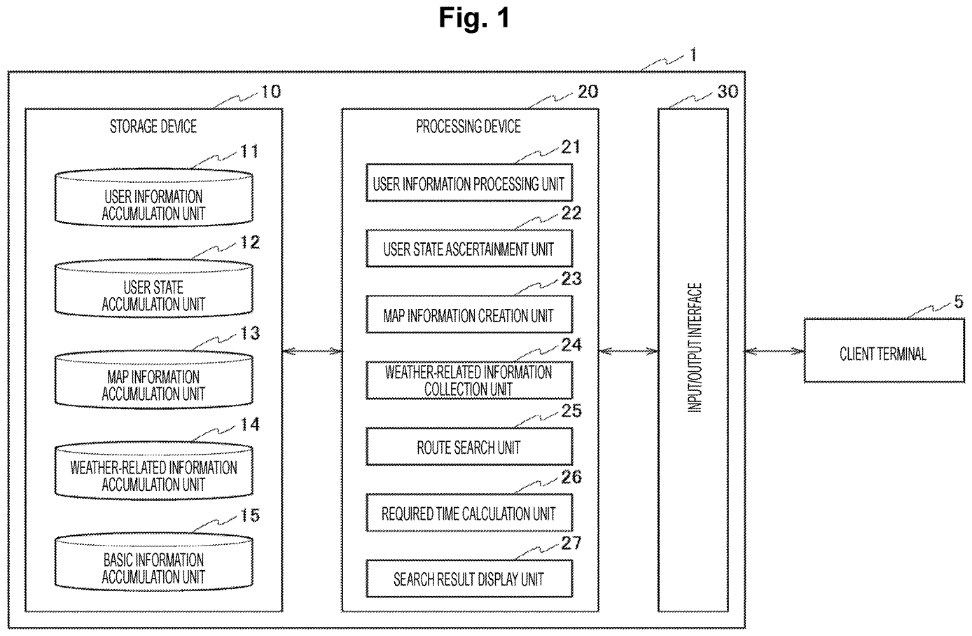

A route presentation apparatus 1 according to the present embodiment will be described with reference to FIG. 1. The route presentation apparatus 1 and a client terminal 5 are connected via a network. The client terminal 5 is a terminal used by a user, and for example, a personal computer, a tablet terminal, a mobile terminal, or the like can be used. The route presentation apparatus 1 presents routes to a destination and a required time according to the user for each route in response to a request from the client terminal 5.

The route presentation apparatus 1 illustrated in FIG. 1 can use a general computer including a storage device 10, a processing device 20, and an input/output interface 30. The computer executes a program to function as each unit of the route presentation apparatus 1 illustrated in FIG. 1.

The storage device 10 may be a read only memory (ROM), a random access memory (RAM), a hard disk drive (HDD), a solid state drive (SSD), or the like. The storage device 10 stores various types of data such as input data, output data, and intermediate data necessary for the processing device 20 to execute processing.

The processing device 20 is a central processing unit (CPU) or a graphics processing unit (GPU) to function as the route presentation apparatus 1, and reads data stored in the storage device 10, writes data in the storage device 10, and inputs/outputs data to/from the input/output interface 30.

The input/output interface 30 inputs a request from the client terminal 5 received via the network to the processing device 20, and transmits a processing result obtained by the processing device 20 to the client terminal 5 via the network. Furthermore, the input/output interface 30 receives various types of information via the network and inputs the information to the processing device 20.

The storage device 10 includes a user information accumulation unit 11, a user state accumulation unit 12, a map information accumulation unit 13, a weather-related information accumulation unit 14, and a basic information accumulation unit 15.

The user information accumulation unit 11 accumulates user information regarding a user who uses the client terminal 5. The user information includes, for example, user basic information such as a name, a date of birth, a sex, and an address of the user, and option information for obtaining a walking speed of the user. The option information is step number information obtained from a pedometer or a step number application, results of physical strength diagnosis tests, and the like. The step number information is, for example, the number of steps per day, a walking time, or a walking speed. The results of physical strength diagnosis tests are used as reference information in a case where the walking speed of the user has not been accumulated.

The user state accumulation unit 12 accumulates information regarding a current state of the user. A state of the user includes, for example, position information and a current walking speed of the user. A state of the user may include a health state of the user.

The map information accumulation unit 13 accumulates information related to a map. The information related to the map includes, for example, map information including information necessary to search for a route, elevation data, disaster prevention facility information, and disaster prediction information. The disaster prevention facility information is, for example, shelter, evacuation spot, water supply base, medical institution, toilet, or barrier free information. The disaster prediction information is, for example, various hazard maps, a tsunami height, an influence start time, or a tsunami arrival time.

The weather-related information accumulation unit 14 accumulates weather information or disaster information. The weather information is, for example, information regarding the current position of the user, information regarding the current weather of a destination, or information regarding a future weather forecast. The disaster information is, for example, various warnings, a tsunami arrival time and a tsunami height at the time of occurrence of a tsunami, water level information of a river at the time of landing of a typhoon, earthquake early warning, disaster-related information issued by a local public organization, or the like.

The basic information accumulation unit 15 includes basic information for calculating a time required for moving along a route according to the user. The basic information includes, for example, a walking speed, stride information, and a decrease rate of the number of steps at an inclination angle for each age group, age, or gender. The basic information is input to the basic information accumulation unit 15 in advance during system operation.

The processing device 20 includes a user information processing unit 21, a user state ascertainment unit 22, a map information creation unit 23, a weather-related information collection unit 24, a route search unit 25, a required time calculation unit 26, and a search result display unit 27.

The user information processing unit 21 receives an input of the user basic information and the option information, and stores the user basic information and the option information in the user information accumulation unit 11. In a case where the option information is not input, the user information processing unit 21 may identify a walking speed or stride information of the user on the basis of the user basic information with reference to basic information stored in the basic information accumulation unit 15, and store the walking speed or the stride information in the user information accumulation unit 11.

The user state ascertainment unit 22 receives information indicating the state of the user from the client terminal 5 at a normal time such as when the user is moving, and stores the information in the user state accumulation unit 12. The information indicating the state of the user is, for example, position information, walking speed, or stride information of the user. The position information can be obtained using a geolocation technology. For example, the position information may be acquired from a device such as a GPS included in the client terminal 5, or information from a Wi-Fi access point or a base station may be used. In a case where the position information cannot be obtained, a place name, selection on a map, landmark information, or the like may be directly received from the user to identify the current position of the user. The walking speed and the stride information may be calculated using information obtained from a pedometer. For example, when the user is walking continuously for a specified time or more, a walking speed can be calculated by dividing a moving distance by a moving time.

The map information creation unit 23 collects information related to a map and stores the information in the map information accumulation unit 13. In addition, the map information creation unit 23 creates a map including routes from the current position of the user to a destination. The map information creation unit 23 may divide the disaster prevention facility information or the disaster prediction information stored in the map information accumulation unit 13 into layers and arrange the layers on the map.

The weather-related information collection unit 24 collects weather information or disaster information based on the current position of the user and stores the information in the weather-related information accumulation unit 14. For example, the weather-related information collection unit 24 collects weather information or disaster information on a route designated by route search, disaster information of an area including an evacuation spot within a certain range including the current position, or disaster information of an area within a certain range including a destination of the user, and stores the information in the weather-related information accumulation unit 14. The weather-related information collection unit 24 may collect not only current weather information or disaster information but also past to present and present to future weather information or disaster information and store the collected information in the weather-related information accumulation unit 14.

Upon receiving a route search request from the client terminal 5, the route search unit 25 searches for a route to a destination using the map information stored in the map information accumulation unit 13. For example, in a case where the route search request is a route search for evacuation, the route search unit 25 searches the disaster prevention facility information stored in the map information accumulation unit 13 for an evacuation spot suitable for the user on the basis of the position information of the user stored in the user state accumulation unit 12, and searches for a route from the current position of the user to a destination having the evacuation spot as the destination. At the time of extracting a destination, the route search unit 25 increases priorities of places available for evacuation in a living area on the basis of the walking history of the user. In the case of no geographical advantage, the priorities of shelters provided by local governments are increased in consideration of the easiness of access and the easiness of information collection. In a case where the user uses a wheelchair, information of a barrier free map is used to search for a route to a shelter depending on the situation of the user. For example, information such as presence or absence of a toilet, an elevator, a slope, and a braille block is used.

A route search request may include disaster information causing evacuation, such as heavy rain, an earthquake, or tsunami. The route search unit 25 searches for a destination and a route according to disaster information. For example, in a case where tsunami occurs, the route search unit 25 sets an evacuation spot on a high ground where the tsunami does not reach as a destination. In a case where a departure position and a destination are designated in a route search request, the route search unit 25 may search for routes from the departure position to the destination.

The route search unit 25 obtains inclination angles of roads on the routes from elevation differences for each searched route, and transmits the inclination angles to the required time calculation unit 26 in association with the routes as information related to the routes.

In a case where transportation is used, the route search unit 25 may use transportation operation information for searching for a route.

The required time calculation unit 26 calculates a required time to the destination in consideration of the state of the user for each route searched by the route search unit 25. Specifically, the required time calculation unit 26 corrects the walking speed by multiplying the walking speed stored in the user information accumulation unit 11 or the user state accumulation unit 12 by a decrease rate obtained from an inclination angle on a route, and calculates a required time to arrive at the destination using the corrected walking speed. The required time calculation unit 26 may preferentially use the walking speed stored in the user state accumulation unit 12. For example, if the walking speed is stored in the user state accumulation unit 12, the walking speed stored in the user state accumulation unit 12 is used, and if the walking speed is not stored in the user state accumulation unit 12, the walking speed stored in the user information accumulation unit 11 is used. The required time calculation unit 26 may calculate the required time using the stride information instead of the walking speed.

At the time of calculating a required time, the required time calculation unit 26 reads a decrease rate according to an inclination angle from the basic information accumulation unit 15 and multiplies the walking speed by the decrease rate. As the inclination angle increases, the decrease rate increases. Note that it is assumed that there is no change in the walking speed on a downhill.

For example, the required time calculation unit 26 divides inclinations into four stages by angles, and obtains a distance dₙ(n=1, 2, 3, and 4) of each stage n of inclinations on a route. The required time calculation unit 26 reads the decrease rate in each stage from the basic information accumulation unit 15, and obtains a walking speed sₙ(n=1, 2, 3, and 4) of each stage n by multiplying the walking speed by the decrease rate. The required time calculation unit 26 obtains a required time TR(k) of a route R(k) using the following expression (1). k represents an identification number of the route.

$$\begin{matrix}[ Math . 1 ] & \\ {T}_{R ( k )} = {\sum }_{n} ( \frac{{d}_{n}}{{s}_{n}} ) & ( 1 )\end{matrix}$$

The required time calculation unit 26 may determine the priority of a route. For example, the required time calculation unit 26 determines the priority of the route on the basis of difficulty in walking on the route, whether the route passes through a warning level region, and whether the route passes through a region where a disaster occurred in the past. Specifically, the priority of the route is determined by the following processing.

The required time calculation unit 26 obtains an expected value E_{R(k) (inclination)} of difficulty of walking on the route R(k) using the following expression (2) on the basis of inclination information. d_{R(k)} represents the overall distance of the route R(k).

$$\begin{matrix}[ Math . 2 ] & \\ {E}_{R ( k ) ( inclination )} = {\sum }_{n} n ( \frac{{d}_{n}}{{d}_{R ( k )}} ) & ( 2 )\end{matrix}$$

The required time calculation unit 26 obtains an expected value E_{R(k) (encounter)} of a disaster encounter on the route R(k) using the following equation (3) on the basis of a warning level of weather information.

$$\begin{matrix}[ Math . 3 ] & \\ {E}_{R ( k ) ( encounter )} = {\sum }_{p} {a}_{p} ( {\sum }_{i} R ( k ) \cdot {r ( a )}_{i} ) & ( 3 )\end{matrix}$$

Here, R(k)·r(a) represents whether the route R(k) has passed through a warning level region r(a). In a case where the route R(k) does not pass through the warning level region r(a), R(k)·r(a)=0, and in a case where the route R(k) passes through the warning level region r(a), R(k)·r(a)=1. i represents the number of warning level regions, and aₚ(p=1, 2, 3, 4, 5) represents a numerical value of a warning level.

The required time calculation unit 26 obtains an expected value E_{R(k) (disaster)} of a past disaster occurrence place of the route R(k) using the following expression (4) on the basis of past disaster occurrence places.

$$\begin{matrix}[ Math . 4 ] & \\ {E}_{R ( k ) ( disaster )} = {\sum }_{q} {d}_{q} ( {\sum }_{j} R ( k ) \cdot {r ( d )}_{j} ) & ( 4 )\end{matrix}$$

Here, R(k)·r(d) represents whether the route R(k) has passed through a disaster occurrence region r(d). In a case where the route R(k) does not pass through the disaster occurrence region r(d), R(k)·r(d)=0, and in a case where the route R(k) passes through the disaster occurrence region r(d), R(k)·r(d)=1. j represents the number of disaster occurrence regions, and d_{q}(q=1, 2, 3, 4, 5) represents a numerical value of a disaster damage level.

The required time calculation unit 26 obtains PR(k) by the following expression (5) using the expected values obtained for the route R(k), and prioritizes the value of the obtained PR(k) in ascending order.

$$\begin{matrix}[ Math . 5 ] & \\ {P}_{R ( k )} = α {E}_{R ( k ) ( inclination )} + β {E}_{R ( k ) ( encounter )} + γ {E}_{R ( k ) ( disaster )} & ( 5 )\end{matrix}$$

α, β, and γ are weighting coefficients for the respective expected values.

The required time calculation unit 26 transmits information on routes and required times to the search result display unit 27. The information on routes may include information such as inclination angles on the routes and priorities.

The search result display unit 27 displays the searched routes and the required time of each route on a map, and returns a display screen on which various types of information such as weather information or disaster information is superimposed to the client terminal 5. Various types of information to be superimposed can be designated by the user. For various types of information to be superimposed that change with time, such as rain cloud radar or lightning forecast, the user may designate a time zone.

Next, an example of processing of the route presentation apparatus 1 will be described.

As initial setting of the present system, basic information including walking speeds, stride information, and decrease rates of the numbers of steps at inclination angles for each age group, age, and sex is stored in the basic information accumulation unit 15. Further, user basic information and option information are stored in the user information accumulation unit 11 for each user.

During normal use of the present system, the user state ascertainment unit 22 receives information regarding the state of the user from the client terminal 5, and stores the position information of the user, the number of steps for a certain period of time at the present time, the moving distance for a certain period of time at the present time, and the walking speed at the present time in the user state accumulation unit 12. The map information creation unit 23 collects map information, disaster prevention facility information, and disaster prediction information as necessary, and stores the information in the map information accumulation unit 13. The weather-related information collection unit 24 collects weather information or disaster information depending on the position information of the user and stores the information in the weather-related information accumulation unit 14.

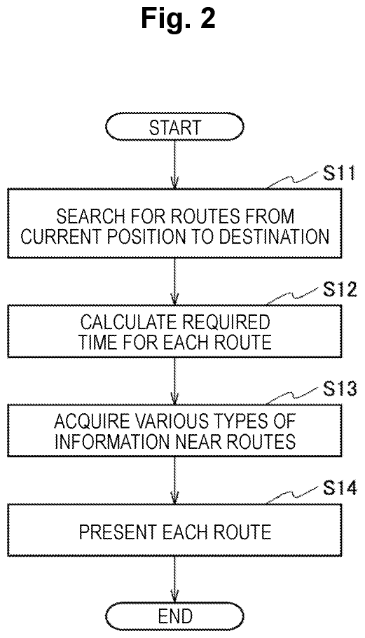

At the time of occurrence of a disaster, the client terminal 5 notifies the user that evacuation is necessary, and inquires whether it is necessary to search for a route to a shelter. For example, the client terminal 5 displays a route search button on a screen. When the user presses the route search button, the client terminal 5 transmits a route search request to the route presentation apparatus 1. The route presentation apparatus 1 receives the route search request and executes processing illustrated in the flowchart of FIG. 2.

In step S11, the route search unit 25 searches for a route from the current position to a destination. Specifically, the route search unit 25 acquires a current position of the user from the user state accumulation unit 12, acquires information regarding the user from the user information accumulation unit 11 and the user state accumulation unit 12, acquires disaster prevention facility information and disaster prediction information from the map information accumulation unit 13, and extracts a destination suitable for the user. The route search unit 25 may extract a plurality of destinations. The route search unit 25 searches for routes from the current position to the destination with reference to the map information accumulation unit 13. In a case where a departure place, a destination, and a desired arrival time are included in the route search request, the route search unit 25 searches for routes from the departure place to the destination.

In step S12, the required time calculation unit 26 calculates a required time for each of the searched routes. Specifically, the required time calculation unit 26 acquires the walking speed of the user from the user state accumulation unit 12. In a case where the walking speed is not stored in the user state accumulation unit 12, the required time calculation unit 26 acquires the walking speed of the user from the user information accumulation unit 11. The required time calculation unit 26 may acquire stride information from the user information accumulation unit 11 or the user state accumulation unit 12. For each route, the required time calculation unit 26 obtains a required time from the distance of the route and the walking speed or the stride information of the user, further obtains a decrease rate of the walking speed or the stride from inclination angles on each route, and adds a time that increases according to the distance of an inclined portion and the decrease rate to the required time.

In step S13, the search result display unit 27 acquires various types of information near the routes. For example, the search result display unit 27 acquires weather information or disaster information of an area including the current position and the destination from the weather-related information accumulation unit 14. The search result display unit 27 may acquire past or future information.

In step S14, the search result display unit 27 displays each route on the map together with the required time, and causes the client terminal 5 to display a screen on which the various types of information acquired in step S13 are superimposed.

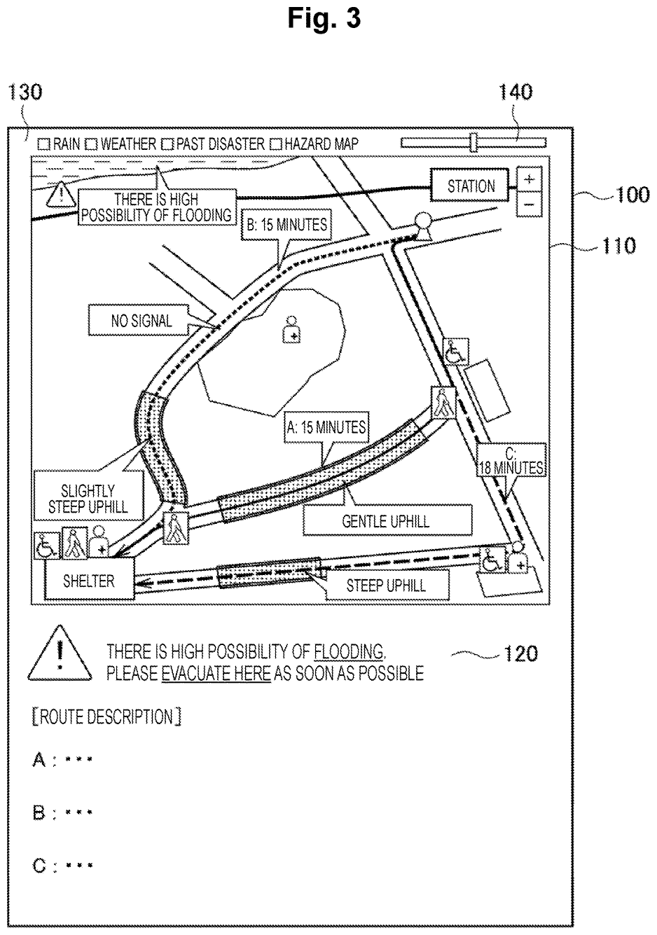

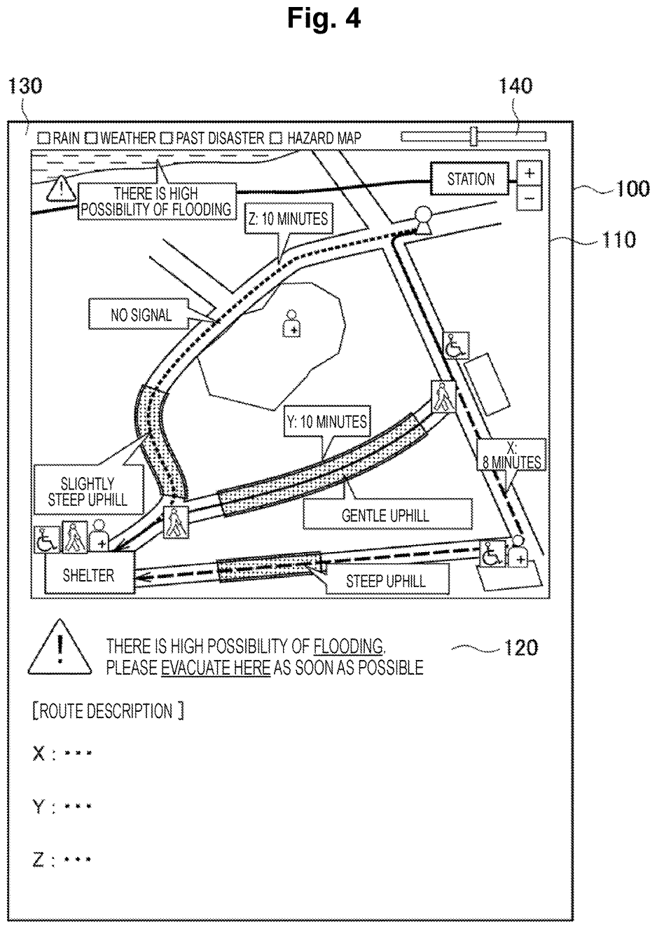

Next, an example of a display screen will be described with reference to FIGS. 3 and 4. FIG. 3 is an example of a display screen presenting routes for people with weak legs and hips, and FIG. 4 is an example of a display screen presenting routes for healthy people.

The display screens 100 in FIGS. 3 and 4 include a map display area 110, a message display area 120, a display information selection area 130, and a slide bar 140. Note that the screen configuration is an example, and is not limited thereto.

In the map display area 110, a map including a current position and a destination of a user, routes searched by the route presentation apparatus 1, and various types of information are displayed in a superimposed manner. For example, in the map display area 110, a map layer, a route search result layer, a weather and disaster information layer, a past disaster information layer, and a hazard map layer are displayed in a superimposed manner. A map and disaster prevention facility information are displayed on the map layer. In the route search result layer, the current position of the user, the destination, and route search results are displayed. A required time of each route and information (inclination information and the like) on caution points on the route may be displayed in the route search result layer. In the weather and disaster information layer, weather information including predictions and disaster information (watch and warnings) are displayed. Past disaster information (sediment disaster spots, flooded areas, and the like) is displayed in the past disaster information layer. A hazard map issued by each local government is displayed on the hazard map layer. Since there are a plurality of types of hazard maps including a flood, an internal water, a reservoir, a high tide, a tsunami, a sediment disaster, a volcanic eruption, and an earthquake, an appropriate hazard map is displayed in response to a disaster. The aforementioned layers are examples, and the layers are not limited thereto. Note that each layer may be turned on and off. The map displayed in the map display area 110 may be enlarged or reduced according to user operation.

Regarding the route search result layer, route A, route B, and route C are displayed together with required times in FIG. 3, and route X, route Y, and route Z are displayed together with required times in FIG. 4. Route A, route B, and route C in FIG. 3 correspond to route Y, route Z, and route X in FIG. 4, respectively. Since recommended routes change according to the state of the user, route C that is a third possibility in FIG. 3 is presented as a first possibility (route X) in FIG. 4. The map display area 110 also displays the required time and inclination information with respect to each route. Inclined points on a route may be displayed in an easy-to-recognize manner by changing a display mode.

In the message display area 120, a warning message and route description are displayed. The warning message displays currently issued warning, watch, or disaster information. In the route description, description of each route is described in order of priority. For example, information on an uphill on a route, road visibility, information on a mark of a corner, and the like are described. In the example of FIG. 3, since a person with weak legs/feet has a low walking speed on a steep uphill and there is a risk of falling down, route A in which a gentle uphill continues although the distance is long is presented as a first possibility, and route B in which there is no signal at an intersection and a slightly steep uphill is included is presented as a second possibility. In the example of FIG. 4, a healthy person can walk without difficulty even on a steep uphill, and thus route X that is straight and has high visibility is presented as the first possibility. Although route Y and route Z have the same required time, route Z needs to pass through an intersection without a traffic light, and thus route Y that is a gentle uphill is presented as a second possibility in consideration of route safety.

In the display information selection area 130, check boxes for selecting various types of information to be superimposed and displayed on the map display area 110 are arranged. Display of the corresponding layer in the map display area 110 is turned on and off by turning on and off a check box.

The slide bar 140 is used to designate the time of various types of information displayed in the map display area 110. For example, when the slide bar 140 is shifted to the left, a weather condition before a reference time (for example, current time, estimated time of arrival, or the like) is displayed in the map display area 110. When the slide bar 140 is shifted to the right, a predicted weather condition is displayed.

As described above, the route presentation apparatus 1 of the present embodiment includes the user state accumulation unit 12 that stores information indicating a state of a user, the route search unit 25 that searches for at least one or more routes to a destination, the required time calculation unit 26 that calculates a required time according to the state of the user for each route, and the search result display unit 27 that displays the routes and the required times of the routes on a map. As a result, routes in consideration of the state of the user can be presented.

In the route presentation apparatus 1 of the present embodiment, the required time calculation unit 26 calculates the required time of each route using the walking speed or the stride based on the state of the user, and further calculates the required time by decreasing the walking speed or the stride in response to an inclination angle on the route. As a result, routes more suitable for the state of the user can be presented.

In the route presentation apparatus 1 of the present embodiment, the required time calculation unit 26 prioritizes a route on the basis of a difficulty of walking on the route, a possibility of a disaster encounter on the route, and a past disaster occurrence situation on the route. As a result, safer routes can be presented.

Note that, even in daily life in which no disaster has occurred, the route presentation apparatus 1 of the present embodiment can present safer routes in consideration of the state of the user, weather information or weather forecast in a time zone of moving to a destination, and past disaster information.

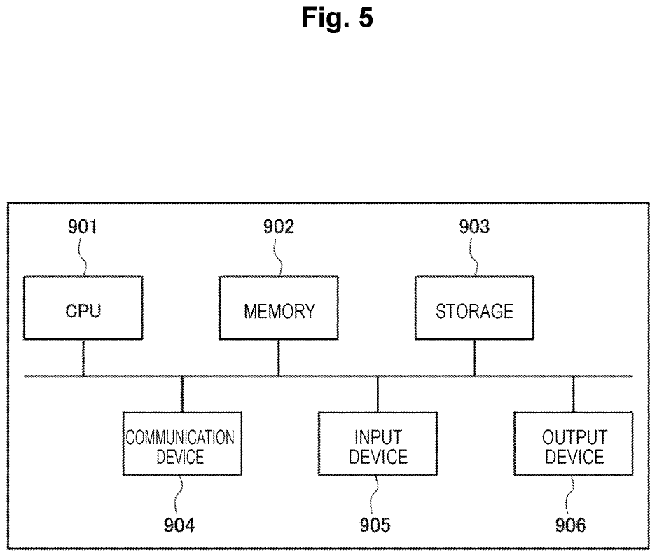

As the above-described route presentation apparatus 1, for example, a general-purpose computer system including a central processing unit (CPU) 901, a memory 902, a storage 903, a communication device 904, an input device 905, and an output device 906 as illustrated in FIG. 5 can be used. In this computer system, the CPU 901 executes a predetermined program loaded on the memory 902, thereby realizing the route presentation apparatus 1. This program can be recorded on a computer-readable recording medium such as a magnetic disk, an optical disc, or a semiconductor memory, or can be distributed via a network.

### REFERENCE SIGNS LIST

1 Route presentation apparatus
10 Storage device
11 User information accumulation unit
12 User state accumulation unit
13 Map information accumulation unit
14 Weather-related information accumulation unit
15 Basic information accumulation unit
20 Processing device
21 User information processing unit
22 User state ascertainment unit
23 Map information creation unit
24 Weather-related information collection unit
25 Route search unit
26 Required time calculation unit
27 Search result display unit
30 Input/output interface
5 Client terminal

1. A route presentation apparatus comprising:
a user state accumulation unit, including one or more processors, configured to store information indicating a state of a user;
a route search unit, including one or more processors, configured to search for at least one route to a destination;
a required time calculation unit, including one or more processors, configured to calculate a required time in response to the state of the user for each of the route; and
a search result display unit, including one or more processors, configured to display the route and the required time for the route on a map.

2. The route presentation apparatus according to claim 1, wherein the required time calculation unit is configured to calculate the required time using a walking speed or a stride based on the state of the user.

3. The route presentation apparatus according to claim 2, wherein the required time calculation unit is configured to calculate the required time by decreasing the walking speed or the stride in response to an inclination angle on the route.

4. The route presentation apparatus according to claim 1, wherein the required time calculation unit is configured to prioritize the route based on a difficulty of walking on the route, a possibility of a disaster encountered on the route, and a past disaster occurrence situation on the route.

5. The route presentation apparatus according to claim 1, wherein the search result display unit is configured to superimpose and display weather information or disaster information on a map.

6. The route presentation apparatus according to claim 1, wherein the route search unit is configured to select a destination based on the state of the user.

7. A method comprising:
searching, by one or more processors, for at least one route to a destination;
calculating, by the one or more processors, a required time in response to a state of a user for each of the route; and
displaying, by the one or more processors, the route and the required time for the route on a map.

8. A program causing a computer to operate as each unit of the route presentation apparatus according to claim 1.
